(19) United States
(12) Patent Application Publication
(10) Pub. No.: US 2025/0383904 A1
(43) Pub. Date: Dec. 18, 2025

(54) METHOD AND SYSTEM FOR HORIZONTALLY INCREASING THE NUMBER OF POD REPLICAS

(71) Applicant: Intuit, Inc., Mountain View, CA (US)

(72) Inventors: Shreyas BADIGER MAHADEV, Santa Clara, CA (US); Xiaotang SHAO, Cupertino, CA (US); Hui LUO, Fremont, CA (US); Yuxuan ZHU, Sunnyvale, CA (US)

(21) Appl. No.: 18/744,426

(22) Filed: Jun. 14, 2024

(51) Int. Cl. G06F 9/455

(52) U.S. Cl. CPC G06F 9/45558; G06F 2009/45583

(57) ABSTRACT

Certain aspects provide a computer-implemented method for automatically increasing the maximum number of pod replicas to meet an increasing demand for services provided by the applications or microservices running in the pod replicas. The method monitors current pod replicas that run an application or microservice in a cluster of nodes. The method determines a recommended maximum number of pod replicas (RMR) that is greater than a current maximum number of pod replicas in response to detecting a change in the current pod replicas. The method includes executing an increased number of pod replicas to run the application or the microservice in the cluster based on the RMR. The increased number of pod replicas is greater than a current number of the pod replicas and is less than the RMR.

### BACKGROUND

### Field

Aspects of the present disclosure relate to virtualization, and in particular, to scaling pod replicas running a node cluster.

### Description of Related Art

Traditionally, software was implemented in monolithic applications run on physical computer systems. A monolithic application is a self-contained software program in which the user interface, application programming interfaces, data processing, and data access code are implemented in a single program. However, running multiple monolithic applications on the same computer system created resource sharing conflicts because monolithic applications run independently of one another. For example, if multiple monolithic applications are run on the same computer system, typically one of the applications dominates resource usage. As a result, the other applications running on the same computer system are delayed or underperform. One solution was to run each application on a different computer system. This approach created increased costs to maintain a separate computer system for each instance of an application and resulted in underutilized or wasted resources because not all applications use resources in the same manner across the computer systems.

Virtualization was introduced to help resolve issues associated with underutilized and wasted resources and increase computational efficiency and productivity. Virtualization allows for the creation of multiple virtual machines (VMs) to run multiple applications on a single computer system and paved the way for distributed applications that are composed independent application components called microservices that run separately in VMs. VMs virtualize the computer system down to the hardware layer, including virtualization of the CPU, memory, and storage, and independently run applications or microservices on separate operating systems (OSs). Although each VM runs its own OS and functions separately from other VMs running on the same computer system, virtualization management tools have been developed to ensure that VMs running on the same computer system share computer resources to increase efficiency and reduce resource wastage and bottlenecks.

In recent years, virtualization has expanded to include containers for running applications and microservices. A container is a software package that contains the application or microservice and dependencies, such as libraries and files, used to run the application or microservice. By contrast to VMs, containers virtualize software layers above the OS level. In other words, containers are similar to VMs in running applications and microservices in separate virtual environments, but containers have relaxed isolation properties in order to share the same OS among the containers running on the same computer system. As a result, a single OS can support multiple containers, each container running within a separate execution environment.

Containers are run in pods. Each pod contains a group one or more containers. A container run in a single pod can contain a full application, including dependencies to run the application. Multiple containers can run in the same pod when the applications or microservices that run in the containers depend on one another and share network, files, storage, and data.

Platforms for managing containerized workloads have been developed to respond to changing demands for services, to evenly distribute traffic and processing, or to reduce the downtime of an application or microservices by creating replicas of pods (i.e., pod replicas) that run multiple instances of the same application or microservice. However, these platforms are limited to scaling the number of pod replicas within a fixed range that is bounded by a minimum number of pod replicas and a maximum number of pod replicas. By not permitting the number of pod replicas to exceed the maximum when demand for services provided by the applications or microservices is high and computer resources, such as CPU, memory, and network, are available, the maximum number of pod replicas reduces computational efficiency and productivity and is the source of frustration for users. For example, if the number of pod replicas is at maximum and the demand for services provided by applications running in pod replicas continues to increase, the limited number of pod replicas that are available to respond to requests for services increases the response time. Failure to respond to requests in a timely manner results in requests for services timing out, frustrates users, and in the case of an online retail business, a delayed or no response may drive online customers to purchase products from other online retailers and damage the business's reputation.

### SUMMARY

Certain aspects provide a computer-implemented method for automatically increasing the maximum number of pod replicas to meet an increasing demand for services provided by the applications or microservices running in the pod replicas. The method monitors current pod replicas that run an application or microservice in a cluster of nodes. The method determines a recommended maximum number of pod replicas (RMR) that is greater than a current maximum number of pod replicas in response to detecting a change in the current pod replicas. The current maximum number of pod replicas is overwritten in an HPA manifest with the RMR. The method includes executing an increased number of pod replicas to run the application or the microservice in the cluster based on the RMR recorded in the HPA manifest. The increased number of pod replicas is greater than a current number of the pod replicas and is less than the RMR.

Other aspects provide an apparatus comprising a recommender engine, an updater engine, and a replication controller. The recommender engine is configured to monitor current pod replicas that run an application in a cluster of nodes, to determine a recommended maximum number of pod replicas (RMR) that is greater than a current maximum number of pod replicas in response to detecting that a current number of the pod replicas is near the current maximum number of pod replicas, and to update a horizontal pod autoscaler (HPA) recommendation customer resource (CR) with the RMR. The updater engine is configured to update the current maximum number of pod replicas of an HPA manifest of the application with the RMR in response to detecting the HPA recommendation CR has been updated with RMR. The replication controller is configured to execute an increased number of pod replicas that run the application in the nodes, wherein the increased number of pod replicas that run the application in the nodes is greater than the current number of pod replicas and is less than the RMR.

Other aspects provide processing systems configured to perform the aforementioned method as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example of containers running in pods on a computer system.

FIGS. 2A-2D depict an example of horizontal autoscaling of a pod.

FIG. 3 depicts an example of deploying pod replicas for two applications within minimum and maximum number of pod replica limits.

FIGS. 4A-4B depict an example operation of a horizontal pod autoscaler (HPA) recommender engine comprised of a recommender engine and an updater engine.

FIG. 5 depicts an example HPA recommendation custom resource (CR) manifest.

FIG. 6 depicts a flow diagram of a method for increasing the number of pod replicas in a cluster of nodes.

FIG. 7 depicts a flow diagram of a “determine recommended maximum number of pod replicas (RMR)” process performed in FIG. 6.

FIG. 8 depicts a flow diagram of an “update the maximum number of pod replicas with the RMR” process performed in FIG. 6.

FIG. 9 depicts an example plot of increasing the maximum number of pod replicas to accommodate an increases in the current number of pod replicas.

FIG. 10 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure are directed to a horizontal pod autoscaler (HPA) recommender engine that is configured to automatically increase the maximum number of pod replicas to meet an increasing demand for services provided by the applications or microservices running in the pod replicas. The HPA recommender engine enables the number of pod replicas to be increased beyond a previous fixed maximum number of pod replicas, thereby ensuring an increase in the number of application or microservice instances that are better able to accommodate increases in demand for services.

By contrast, current platforms for scaling the number of pod replicas do not permit the maximum number of pod replicas set in an HPA manifest that sets limits on the number of pod replicas to be increased while the demand for services increases even when there are sufficient resources available to accommodate an increase in the number of pod replicas. By not permitting the number of pod replicas to exceed the maximum as the demand for services increase and resources are available, the maximum number of pod replicas becomes an impediment to computational efficiency and productivity. A fixed maximum number of pod replicas when resources are available can cause a cascade of problems, including longer response times in responding to requests for services, requests for services may time out and have to restart to complete a process, and many applications or microservices that are delayed can shut down which can lead to a cascade of additional failures for other applications or microservices that depend on the output from applications and microservices that are shut down.

With an ever increasing number of users relying on services provided by applications, these failures can have real world consequences. For example, in the case of an online retail business, applications or microservices that fail to timely respond to customer requests frustrates customers, may drive online customers to purchase products from other online retailers, and damage the business's reputation. In the case of organizations that provide remote online monitoring of patient healthcare, a failure by applications and microservices to respond in a timely manner to a patient's monitored condition may result in actual harm to the patient.

Implementations described below are directed to methods and systems that provide a technical solution to the technical problems associated with the current platforms by incorporating an HPA recommender engine that monitors the number of pod replicas and enables the number of pod replicas to be scaled beyond a current maximum number of pod replicas when computational resources are available to handle an increase in the number of pod replicas. The HPA recommender engine monitors the metrics and current number of pod replicas running in a node cluster. The HPA recommender engine includes a recommender engine that checks the current number of pod replicas and if the current number of pod replicas is close to the current maximum number of pod replicas set in a corresponding HPA manifest, the recommender engine determines a recommended maximum number of pod replicas (RMR) that is larger than the current maximum number of pod replicas.

The HPA recommender engine includes an updater engine that checks whether there are enough resources in a resource quota (RQ) for the cluster to accommodate the RMR. The RQ provides constraints that limit the number of pods that can be created in a cluster or limits the number of computational resources per pod replica, such as limits on the amount of CPU and memory that can be used per pod. If the RQ does not provide enough resources to accommodate the RMR, the updater engine increases the resources in the RQ to accommodate horizontal scaling of pod replicas to match the RMR. The updater engine updates the HPA manifest by replacing the current maximum number of pod replicas with the RMR, thereby enabling the number pod replicas to be scaled up beyond the current maximum number of pod replicas as demand for services provided by the applications or microservices running in the pods continues to increase.

The HPA recommender engine solves the problem of current platforms that are restricted by a fixed maximum number of pod replicas in response to an increasing demand for services provided by applications or microservices running in the pod replicas. The HPA recommender engine enables a current maximum number of pod replicas to be replaced by a larger RMR while ensuring there are sufficient computational resources available to accommodate an increase in the number of pod replicas beyond the current maximum number of pod replicas.

### Example Implementation of a Method for Adjusting the Number of Pod Replicas to Meet Increasing Demands for Services

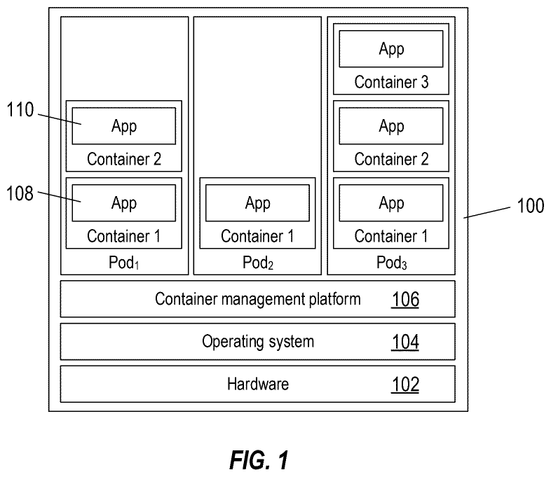

FIG. 1 depicts an example of containers running in pods on a computer system 100. The computer system 100 is an example of a node that includes a hardware layer 102 composed of processors, memory, storage, and network interfaces, such as a high speed network interface card. The computer system 100 includes an OS layer 104 that manages computer hardware, software resources, and provides services for computer programs executing on the computer system 100. A container management platform 106 is a server application for containerizing software and applications. In this example, applications or microservices, denoted by App, are run separately in containers that are, in turn, run in pods identified as “Pod₁,” “Pod₂,” and “Pod₃.” Each pod runs one or more containers with shared CPU, memory, storage and network resources according to a pod specification that includes the names of containers and a request for resources that the pod can use to execute the workloads created by the containers. For example, Pod₁ runs an App 108 in a container identified as “Container 1” and another App 110 in a container identified as “Container 2.” The App 108 and App 110 share a fixed amount of CPU, memory, and storage assigned to Pod₁ according to a pod specification. The pod specification is stored in an in-memory database of a control plane, which manages the nodes and pods. The container management platform 106 manages the pods and does not manage the containers directly.

In other implementations, pods can be run in VMs. The computer systems and VMs that host pods are referred to as nodes. A plurality of nodes is called a cluster. A master node runs a control plane that is comprised of services that handle the scheduling of the pods run in the nodes.

### Horizontal Pod Autoscaling

Pods are often replicated to create more than one pod (i.e., pod replicas) to run multiple instances of the same application or microservice. Pod replicas provide fault-tolerance and high availability of applications and microservices. Fault tolerance is the ability of a cluster to continue operating without interruption when one or more pods fail and prevents service disruptions arising from a single point of failure. Pods are also replicated to avoid overloading applications or microservices by distributing network traffic over multiple pod replicas that run the same applications or microservices.

A horizontal pod autoscaler (HPA) automates horizontal pod scaling to increase performance and optimize allocation of computational resources. Horizontal scaling means that the response to an increased workload of a container in a pod is to deploy more of the same pod (i.e., pod replicas). An HPA monitors specified metrics of a target workload and calculates the desired number of pod replicas to maintain a desired target metric value based on parameters recorded in an HPA manifest for the application running in the pod replicas. The HPA manifest contains settings for monitoring the application running in a pod, such as the metric, a target metric value, a minimum number of pod replicas, and a maximum number of pod replicas. For example, the metric monitored by the HPA can be CPU usage as a percentage of the portion of processing capacity consumed by active tasks compared to a total CPU capacity available; the target CPU value can be fixed value, such as 50%, which serves as a threshold for CPU usage; the minimum number of pod replicas can be set to 1; and the maximum number of pod replicas can be set to 3.

Although implementations are described below with reference to CPU usage as the metric monitored by the HPA, implementations are not intended to be limited to only monitoring CPU usage of the applications or microservices running in containers of the pod replicas. In other implementations, the metric monitored by the HPA includes, but is not limited to, memory usage, transactions per second, latency, error rate, network throughput, or any other suitable metric, such as a custom metric formed as a linear combination of any of the above mentioned metrics.

The HPA calculates a desired number of pod replicas as follows:

$$des\_rep = ceil [ cur\_rep \times \frac{c u rrentMV}{targetMV} ] \qquad ( 1 )$$

where
ceil[X] is the ceiling function that maps a real number X to the smallest integer that is greater than or equal to X;
cur_rep is the current number of pod replicas running in a cluster;
cur_met_val is the current metric value of a metric associated with an application running in one of the pod replicas and is monitored by the HPA; and
tar_met_val is a target metric value that serves as a threshold for usage of a computational resource.

The current number of pod replicas is stored in the HPA controller. The HPA determines whether to scale the number of pod replicas according to Eq. (1) based on the difference between the current metric value and the target metric value. For example, if cur_met_val>tar_met_val+ε, where ε is a tolerance value, the number of pod replicas is scaled up or increased to the desired number of pod replicas calculated according to Eq. (1). Alternatively, if Curₘₑₜ_{ᵥₐₗ}<tar_met_val−ε, the number of pod replicas is scaled down or decreased to the desired number of pod replicas calculated according to Eq. (1).

On the other hand, if cur_met_val<tar_met_val−ε, the number of pod replicas is scaled down to the desired number of pod replicas as calculated according to Eq. (1). The tolerance value & depends on the type of metrics and the units of the metrics. For example, if the metric is CPU usage in percentage units, the tolerance can be set to 2, 5, 10, or another value. On the other hand, if the metric is memory usage in megabytes, the tolerance can be set to 10, 15, 20, or another value.

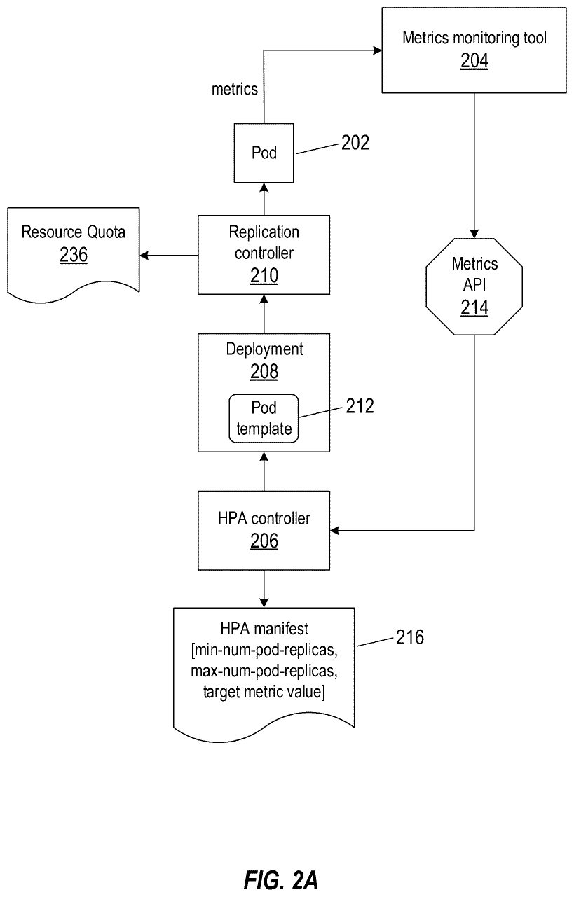

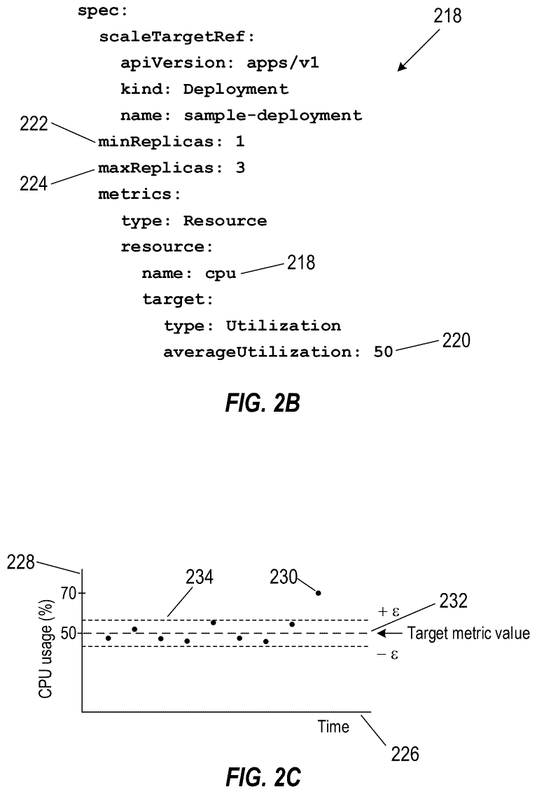

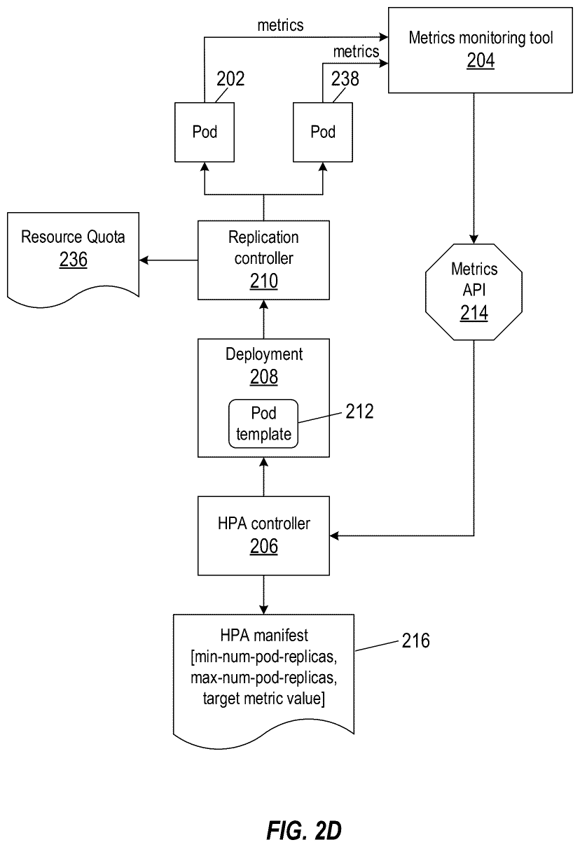

FIGS. 2A-2D depict an example of horizontal autoscaling of a pod. FIG. 2A depicts components used to perform horizontal pod autoscaling of a pod 202. The components include a metrics monitoring tool 204, an HPA controller 206, a deployment 208, and a replication controller 210. The deployment 208 includes a pod template 212 that contains the specification (e.g., CPU allocation and memory allocation) for running the pod 202 on a node in a cluster. In this example, the metrics monitoring tool 204 collects a CPU metric for an application or a microservice running in a container of the pod 202. A metrics application programming interface (API) 214 retrieves current metric values, such as current CPU values and current memory values, associated with running the application or microservice in the pod 202 and forwards the current metric values to the HPA controller 206. The HPA controller 206 compares the current CPU value to a target CPU value in the HPA manifest 216 of the application or microservice running in the pod 202. Alternatively, HPA controller 206 fetches metrics from the metrics API 214 and compares the current memory value to a target memory value in an HPA manifest 216 of the application or microservice running in the pod 202.

FIG. 2B depicts an example of contents recorded in the HPA manifest 216. In this example, the HPA manifest 216 identifies the metric to monitor as CPU 218, a target CPU usage 220 as 50 (i.e., 50%), a minimum number of pod replicas 222 set to 1, and a maximum number of pod replicas 224 set to 3.

FIG. 2C depicts an example plot of CPU usage for the pod 202 over time. Horizontal axis 226 represents time. Vertical axis 228 represents a range of CPU usage in percentage units. Solid dots represent CPU usage values at time stamps. Solid dot 230 represents the current CPU value of the container running in the pod 202. In this example, the current CPU value is greater than the target CPU value of 50% represented by dashed line 232 and the tolerance 234.

In FIG. 2A, the HPA controller 206 responds to the current CPU value being greater than the target CPU value and the tolerance, as shown in FIG. 2C, by calculating a desired number of pod replicas according to Eq. (1). HPA controller 206 forwards the desired number of pod replicas to the deployment 208. The deployment 208 forwards the desired number of pods to the replication controller 210. The replication controller 210 fetches information about the limits on resource consumption per namespace from a RQ 236. A namespace is a cluster of pods within a cluster of nodes that provides a way to divide and isolate resources. Limits on computational resources in the RQ 236 are applied at the namespace level. The RQ 236 specifies the maximum amount of each resource that can be consumed within a namespace. Each pod within a namespace specifies a request for a number of CPUs and an amount memory and the maximum or limit the number of CPUs and the amount memory a pod is allowed to consume. For example, the RQ 236 may limit a namespace to a number of CPUs as 2 cores and an amount memory as 4 GB. The RQ 236 may also limit the number of pods in a namespace, such as a limit of 10 pods. The sum of requests and limits on the number of pods within a namespace is used to calculate resource utilization against the RQ 236. The replication controller 210 accesses the information stored in the RQ 236 and will reject the desired number of pod replicas sent from the deployment 208 if the number of computational resources for the pod replicas will exceed the defined limits for the namespace.

FIG. 2D depicts an example of scaling up to two pod replicas. In this example, the HPA controller 206 uses a current CPU value of 70% and the target CPU value of 50% to calculate a desired number of pod replicas equal to 2 according to Eq. (1) (i.e., ceil[1.4]=2). The HPA controller 206 updates the desired number of pod replicas to 2 in the deployment 208. In this example, the replication controller 210 receives the desired number of pod replicas from the deployment 208 and determines that there are sufficient resources to support 2 pod replicas at the node. The replication controller 210 uses the pod template 212 of the pod 202 to create a second pod 238 that is identical to the pod 202. The pods 202 and 238 are pod replicas that run the same application or microservice.

### Maximum Number of Pod Replicas

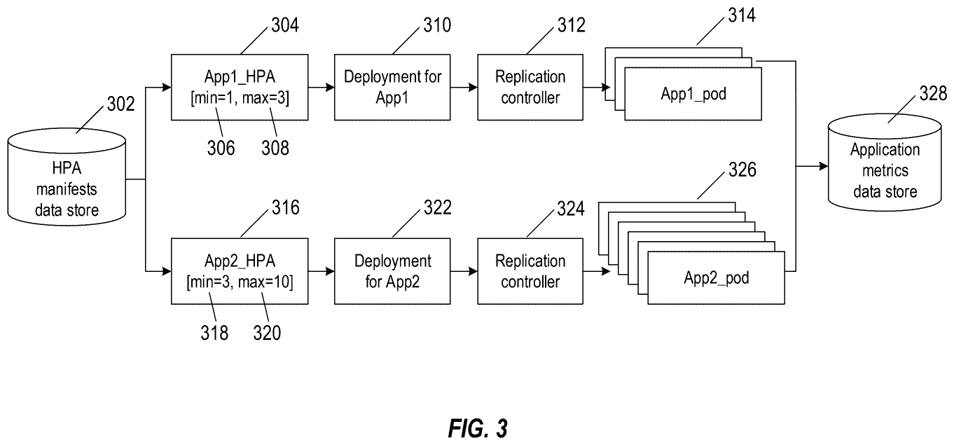

FIG. 3 depicts an example of deploying pod replicas for two applications within the minimum and maximum number of pod replicas limits recorded in corresponding HPA manifests. HPA manifests for the two applications are stored in an HPA manifest data store 302. For a first application denoted by App1, the corresponding App1_HPA manifest 304 fetches the minimum number of pod replicas 306 equal to 1 and the maximum number of pod replicas 308 equal to 3 from a corresponding HPA manifest stored in the data store 302. The App1_HPA manifest 304 computes the desired number of pod replicas according to Eq. (1), but even if the desired number of pod replicas is greater than 3, the HPA manifest 304 can update the deployment 310 to deploy App1 in at most 3 pod replicas. In this example, the replication controller 312 deploys App1 in 3 pod replicas 314 and cannot scale up the number of pod replicas even if the demand for services provided by App1 increases.

For a second application denoted by App2, the corresponding App2_HPA manifest 316 fetches the minimum number of pod replicas 318 equal to 3 and the maximum number of pod replicas 320 equal to 10 from a corresponding HPA manifest stored in the data store 302. The App2_HPA manifest 316 computes a desired number of 6 pod replicas according to Eq. (1). The App2_HPA manifest 316 updates deployment 322 to deploy App2 in 6 pod replicas. The replication controller 324 deploys App2 in 6 pod replicas 326. In this example, the maximum number of pod replicas is set to larger value, which allows for the number of pod replicas to be scaled up 10 pod replicas in order to respond to increasing demand for services provided by App2. Metrics associated with the applications App1 and App2 are stored in an application metric data store 328.

The technical problem created by current platforms is that scaling of the number of pod replicas does not permit the maximum number of pod replicas set in the HPA manifest to be increased even when there are sufficient resources available to accommodate an increased number of pod replicas. By not permitting the number of pod replicas to exceed the maximum number of pod replicas when demand for services is high and resources are available, the maximum number of pod replicas becomes an impediment to computational efficiency and productivity.

### Horizontal Pod Autoscaler Recommender Engine

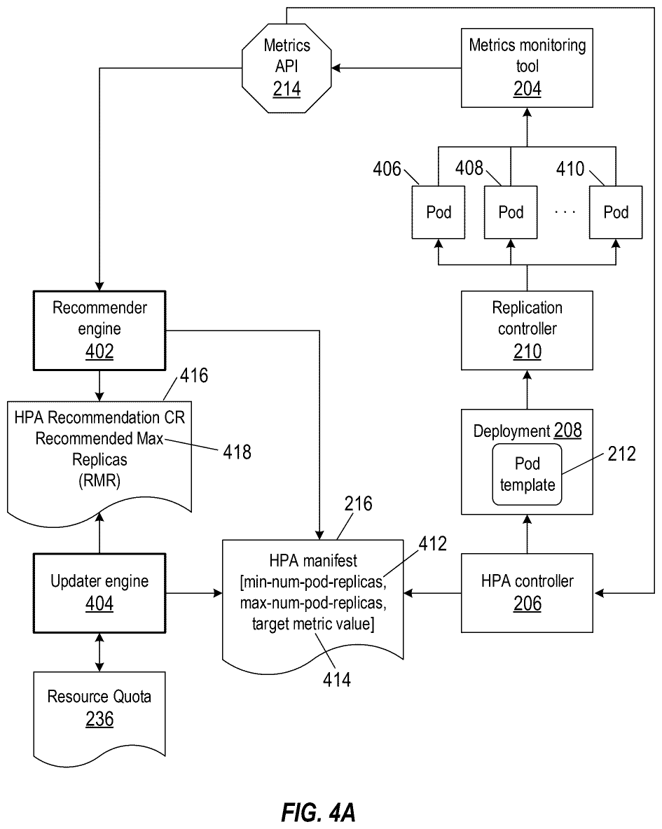

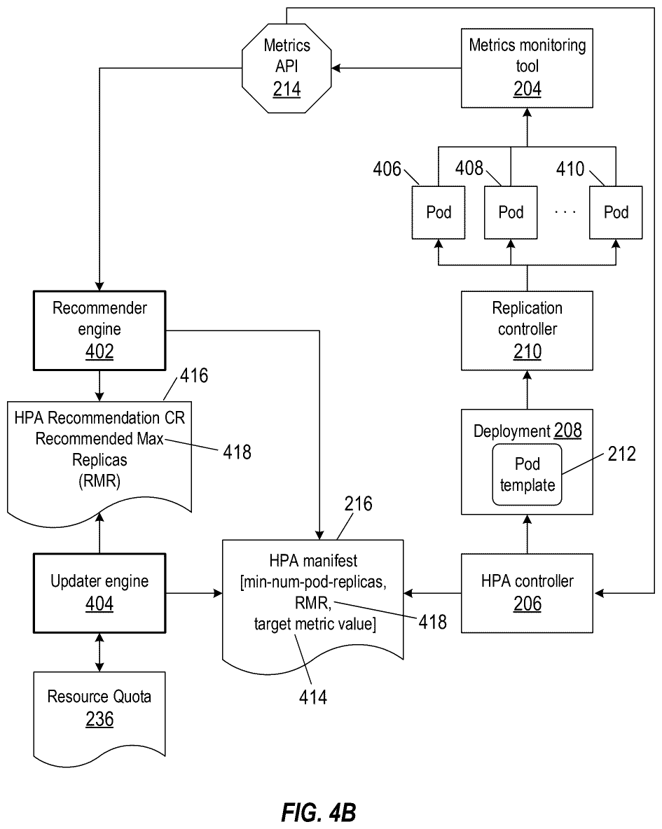

FIG. 4A depicts an HPA recommender engine that is comprised of a recommender engine 402 and an updater engine 404. Unlike current platforms for increasing the number of pod replicas, the HPA recommender engine automatically increases the maximum number of pod replicas in response to increasing demand for services provided by the applications or microservices running in the pod replicas. Three of a plurality of pod replicas are represented by pod replicas 406, 408, and 410. In the example of FIG. 4A, N instances of an application or a microservice are run in containers of the plurality of pod replicas, where Nis positive integer. FIG. 4A also depicts the metrics monitoring tool 204, HPA controller 206, the deployment 208, and the replication controller 210, which in combination execute scaling up or down the number of pod replicas as described above with reference to FIGS. 2A-2D.

The recommender engine 402 is configured to monitor the current metric values of the applications or microservices running in the containers of the pod replicas for a change. For example, the recommender engine 402 detects a change in one of the pod replicas if the following condition is satisfied

$$cur\_met \_val > tar\_met \_val + ε \qquad ( 2 )$$

where cur_met_val is the current metric value of an application or microservice running in one of the pod replicas.

In response to detecting a change in at least one of the pod replicas, the recommender engine 402 extract the maximum number of pod replicas 412 from the HPA manifest 216 and determines whether the current number of pod replicas is near the maximum number of pod replicas. The current number of pod replicas is near the maximum number of pod replicas if the following condition is true:

$$cur\_rep > max\_rep \times T {h}_{config} \qquad ( 3 )$$

where
max_rep is the maximum number of pod replicas 412, and
Th_{config} is a configurable threshold (e.g., Th_{config} can be 0.5, 0.6, 0.7, or 0.8).

If the condition in Eq. (3) is satisfied, then the recommender engine 402 uses the metrics API 214 to fetch a set of current metric values

$${\{ cur\_met \_val ( n ) \}}_{n = 1}^{N}$$

of the metrics of the N applications or microservices running in the pod replicas, where cur_met_val(n) is the n-th current metric value of the N metrics (i.e., n=1, . . . , N). For example, the set of current metric values can be current CPU values or current memory values for the N applications or microservices running in the pod replicas. The recommender engine 402 fetches the target metric value 414 from the HPA manifest 216. For each of the N metrics, the recommender engine 402 calculates the following condition

$$cur\_met \_val ( n ) \times cur\_rep > tar\_met \_val \times max\_rep \times T {h}_{config} \qquad ( 4 )$$

If the current metric value, cur_met_val(n), satisfies the condition in Eq. (4) for any one of the N metrics, then the current number of pod replicas is expected to increase and reach the maximum number of pod replicas. In response, the recommender engine 402 calculates a recommended maximum number of pod replicas (RMR) as follows:

$$R MR = max\_rep \times M \qquad ( 5 )$$

where M is a positive integer scale factor greater than 1 (e.g., 2, 3, 4, or 5).

The recommender engine 402 updates an HPA recommendation custom resource (CR) 416 by writing the RMR 418 calculated in Eq. (5) to the HPA recommendation CR 416.

Consider, for example, an application running in the plurality of pods. The recommender engine 402 monitors the performance of each pod. Suppose the current number of pod replicas running in the cluster is 80 and the maximum number of pod replicas in the HPA manifest is 100. Suppose also that the configurable threshold is set to 0.7 (i.e., Th_{config}=0.7). The recommender engine 402 uses the condition in Eq. (3) to calculate 80>100×0.7=70. As a result, the recommender engine 402 fetches the current metric values for a metric, such as current CPU values or current memory values, of the N applications or microservices running in the plurality of pods from the metrics monitoring tool 204. Suppose one of the current CPU values is 70% and the target CPU value is 60%. The recommender engine 402 uses the condition in Eq. (4) to calculate 0.70×80=56>0.60×100×0.7=42, which indicates that the current number of pod replicas is nearing the maximum number of pod replicas. As a result, the recommender engine 402 uses Eq. (5) to calculate an RMR equal to 200 for M equal to 2.

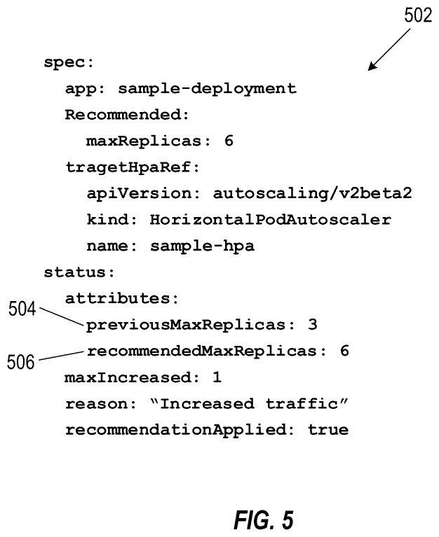

FIG. 5 depicts an example of an HPA recommendation CR 502. In this example, the recommender engine 405 has updated the HPA recommendation CR 502. The previous maximum number of pod replicas 504 is equal to 3 and the RMR 506 is equal to 6.

On the other hand, if the condition in Eq. (3) is not satisfied, the HPA controller 206 calculates a desired number of pod replicas according to Eq. (1). The deployment 208 and replication controller 210 scale up the number of pod replicas to match the desired number of pod replicas as described above with reference to FIGS. 2A-2D.

In FIG. 4B, the updater engine 404 checks the HPA recommendation CR 416 for an update to the RMR 418. If the updater engine 404 determines that the RMR 418 of the HPA recommendation CR 416 has changed since the last time the updater engine 404 checked the HPA recommendation CR 416, the updater engine 404 fetches the RMR from the HPA recommendation CR 416 and checks whether the RMR is greater the maximum number of pod replicas. If the RMR and the maximum number of pod replicas satisfy the following condition

$$R MR > max\_rep \qquad ( 6 )$$

the updater engine 404 determines whether there are sufficient resources in the RQ 236 to support the RMR.

If the updater engine 404 determines that there are insufficient resources to meet the demand for resources of the RMR, then the updater engine 404 increases the number of resources available in the RQ 236 to the amount of resources that can be used by the RMR. For example, if the number of pods is limited to 10 in the RQ 236 and the RMR is 12, then the updater engine 404 increases the pod limit from 10 to 12 in RQ 236. If RQ 236 states that the number of CPUs is limited to 8 cores and the amount of memory is limited to 16 GB for the 10 pods, the updater engine 404 can increase the number of CPUs to 10 cores and the amount of memory to 32 GB to support the increase number of pod replicas in RMR.

In FIG. 4B, the updater engine 404 updates the HPA manifest 216 by replacing or overwriting the maximum number of pod replicas 412 in the HPA manifest 216 of FIG. 4A with the RMR 418. The HPA controller 206 uses the metrics API 214 to fetch the current metric value from the metrics monitoring tool 204, fetches the target metric value 414 and the RMR 418 from the updated HPA manifest 216. The HPA controller 206 calculates a desired number of pod replicas according to Eq. (1). Note that the HPA controller 206 is no longer limited by the previous maximum number of pod replicas 412 of the HPA manifest 216 in FIG. 4A. If the desired number of pod replicas calculated by the HPA controller 206 is greater than the previous maximum number of pod replicas 412 and less than the RMR 418, the deployment 208 and replication controller 210 scale up the number of pod replicas to match the desired number of pod replicas as described above with reference to FIGS. 2A-2D.

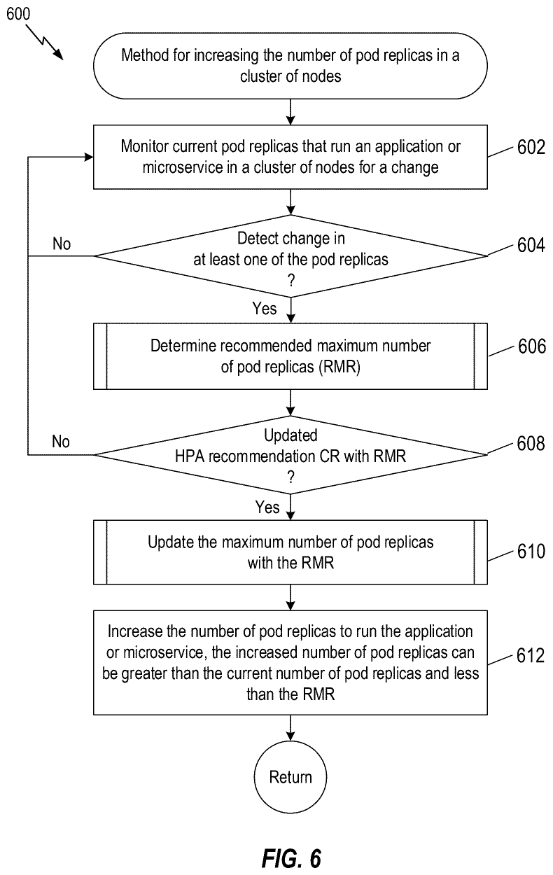

FIG. 6 depicts a flow diagram 600 of a method for increasing the number of pod replicas in a cluster of nodes.

In block 602, the current pods running an application or a microservice are monitored as described above with reference to Eq. (2).

In block 604, if there has been a changed in at least one of the pod replicas, control flow to block 606. Otherwise, control flows to block 602 and the current pod replicas continue to be monitored for a change.

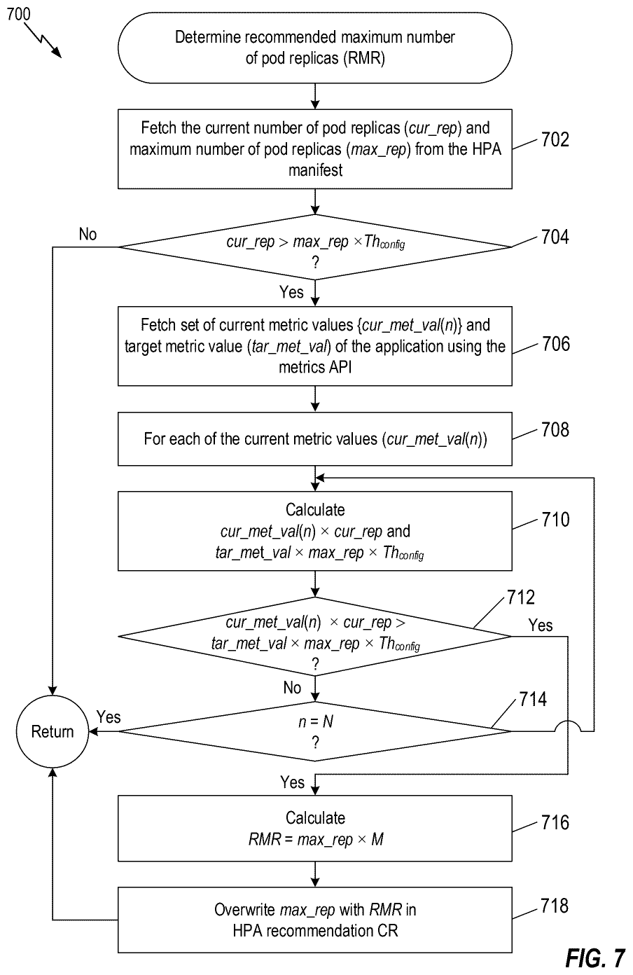

In block 606, a “determine recommended maximum number of pod replicas (RMR)” process is performed. An example implementation of the process of determining the RMR is described below with reference to FIG. 7.

In block 608, if the HPA recommended CR has been update with a current RMR as described above with reference to FIG. 4B, control flow to block 610. Otherwise, control flows to block 602 and the current pod replicas continue to be monitored for a change.

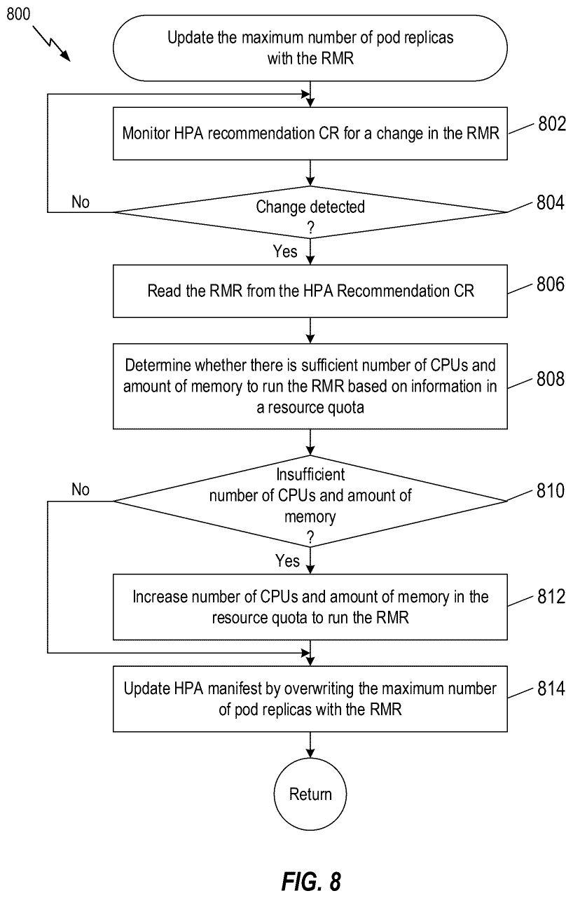

In block 610, an “update the maximum number of pod replicas with the RMR” process is performed. An example implementation of the process of updating the maximum number of pod replicas is described below with reference to FIG. 8.

In block 612, the number of pod replicas that run the application or microservice is increased as described above with reference to FIGS. 2A-2D. The increased number of pod replicas can be greater than the previous maximum number of pod replicas and less the RMR.

The method of FIG. 6 solves the technical problem created by current platforms that limit scaling of the number of pod replicas by the maximum number of pod replicas even when there are sufficient resources available to accommodate an increased number of pod replicas. The method of FIG. 6 permits the number of pod replicas to exceed the previous maximum number of pod replicas when demand for services is high and resources are available by replacing the previous maximum number of pod replicas by the RMR determine in block 606.

FIG. 7 depicts a flow diagram 700 of the process for “determine recommended maximum number of pod replicas (RMR)” executed in block 606 of FIG. 6.

In block 702, the current number of pod replicas (cur_rep) and the maximum number of pod replicas (max_rep) are fetched from the HPA manifest.

In block 704, when the condition in Eq. (3) is true, control flows to block 706. Otherwise, control returns to block 608 in FIG. 6 in which the HPA recommendation CR has not been updated.

In block 706, a set of current metric values {cur_met_val(n)}ₙ₌₁^{N} are fetched using a metrics API 214 from the metrics monitoring tool 204, which is responsible for collecting metrics of the pod replicas as described above with reference to FIGS. 2A and FIGS. 4A-4B.

A loop beginning with block 708 repeats the operations represented by blocks 710 and 712 for each of the current metric values in the set of current metrics values.

In block 710, a product of the current metric value and the number of current pod replicas is calculated and a product of the target metric value, the maximum number of pod replicas, and the configurable threshold is calculated.

In block 712, if the condition in Eq. (4) is satisfied, control flows to block 716. Otherwise, control flows to block 714.

In block 714, if the index n of the current metric value does not equal N, the index is incremented and the operations represented by blocks 710 and 712 is repeated for another of the current metric values in the set of current metric values.

In block 716, the recommended maximum number of pod replicas is calculated as described above with reference to Eq. (5).

In block 718, the maximum number of pod replicas recorded in the HPA recommendation CR is replaced or overwritten by the RMR calculated in block 716.

FIG. 8 depicts a flow diagram 800 of the process “update the maximum number of pod replicas with the RMR” performed in block 610 of FIG. 6.

In block 802, the HPA recommendation CR is monitored for a change in the RMR as described above with reference to FIGS. 4A-4B.

In block 804, when a change in the HPA recommendation CR has been detected, control flows to block 806. Otherwise, control returns to block 802 and the HPA recommendation CR continues to be monitored for changes in the RMR.

In block 806, fetch the RMR from the HPA recommendation CR as described above with reference to FIGS. 4A-4B.

In block 808, determine whether there is a sufficient number of CPUs and amount of memory to run the RMR based on information recorded in a RQ as described above with reference to FIGS. 2A, 2D, and FIGS. 4A-4B.

In block 810, if there is an insufficient number of CPUs and amount of memory, control flow to block 812. Otherwise, control flows to block 814.

In block 812, the number of CPUs and the amount of memory allocated to run the RMR are increased in the RQ.

In block 814, the HPA manifest is updated by overwriting the maximum number of pod replicas (i.e., previous maximum number of pod replicas) with the RMR calculated in block 716 of FIG. 7.

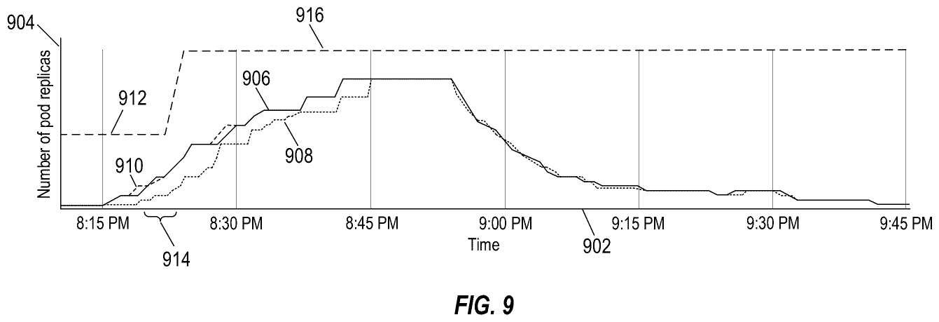

FIG. 9 depicts an example plot of increasing the maximum number of pod replicas to a recommended number of pod replicas to accommodate incremental increases in the current number of pod replicas that may exceed the previous maximum number of pod replicas. Horizontal axis 902 represents time. Vertical axis 904 represents number of pod replicas. Curves 906, 908 and 910 represents the current numbers of pod replicas over time for three different groups of pod replicas. Line segment 912 represent a maximum number of pod replicas. In the time interval 914, the current number of pod replicas increases and gets near to the maximum number of pod replicas represented by line segment 912. An RMR is calculated as described above with reference to FIGS. 6-8. The RMR becomes the new maximum number of pod replicas represented by line segment 916. Note that by increasing to the maximum number of pod replicas from the previous maximum number of pod replicas represented by line segment 912 to the RMR represented by line segment 916 before the current number of pod replicas match the maximum number of pod replicas, the current number of pod replicas are allowed to incrementally increase over time based on an increasing demand for services, thereby preserving computational efficiency and performance and avoiding issues associated with not having sufficient computational resources.

### Example Processing System for Adjusting the Number of Pod Replicas to Meet Increasing Demands for Services

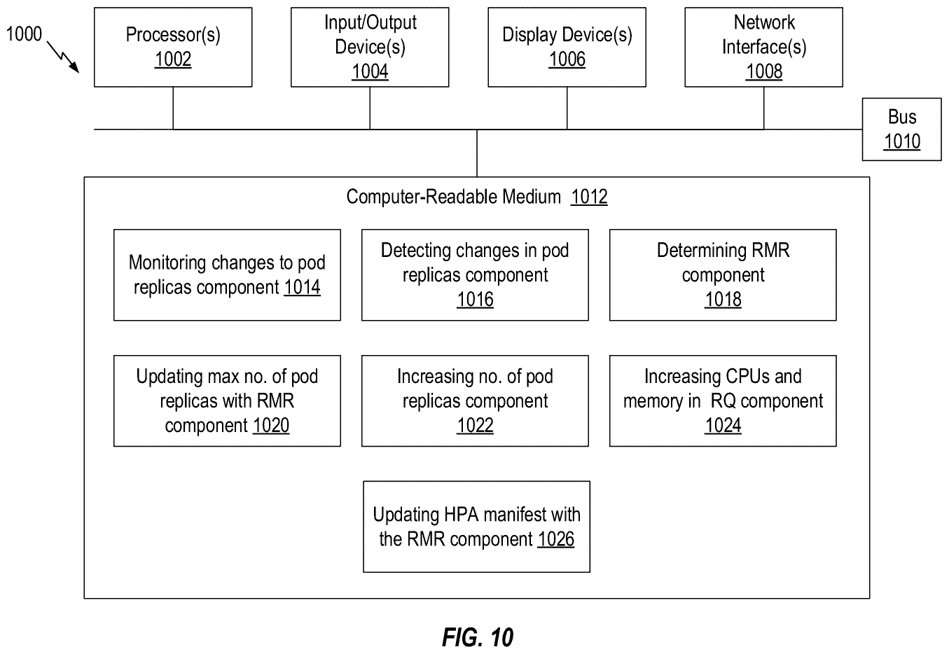

FIG. 10 depicts an example processing system 1000 configured to perform various aspects described herein, including, for example, method for increasing the number of pod replicas in a cluster of nodes as described above with respect to FIGS. 6-8.

Processing system 1000 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1000 includes one or more processors 1002, one or more input/output devices 1004, one or more display devices 1006, one or more network interfaces 1008 through which processing system 1000 is connected to one or more networks (e.g., a local network, an intranet, the Internet, or any other group of processing systems communicatively connected to each other), and computer-readable medium 1012. In the depicted example, the aforementioned components are coupled by a bus 1010, which may generally be configured for data exchange amongst the components. Bus 1010 may be representative of multiple buses, while only one is depicted for simplicity.

Processor(s) 1002 are generally configured to retrieve and execute instructions stored in one or more memories, including local memories like computer-readable medium 1012, as well as remote memories and data stores. Similarly, processor(s) 1002 are configured to store application data residing in local memories like the computer-readable medium 1012, as well as remote memories and data stores. More generally, bus 1010 is configured to transmit programming instructions and application data among the processor(s) 1002, display device(s) 1006, network interface(s) 1008, and/or computer-readable medium 1012. In certain embodiments, processor(s) 1002 are representative of a one or more central processing units (CPUs), graphics processing unit (GPUs), tensor processing unit (TPUs), accelerators, and other processing devices.

Input/output device(s) 1004 may include any device, mechanism, system, interactive display, and/or various other hardware and software components for communicating information between processing system 1000 and a user of processing system 1000. For example, input/output device(s) 1004 may include input hardware, such as a keyboard, touch screen, button, microphone, speaker, and/or other device for receiving inputs from the user and sending outputs to the user.

Display device(s) 1006 may generally include any sort of device configured to display data, information, graphics, user interface elements, and the like to a user. For example, display device(s) 1006 may include internal and external displays such as an internal display of a tablet computer or an external display for a server computer or a projector. Display device(s) 1006 may further include displays for devices, such as augmented, virtual, and/or extended reality devices. In various embodiments, display device(s) 1006 may be configured to display a graphical user interface.

Network interface(s) 1008 provide processing system 1000 with access to external networks and thereby to external processing systems. Network interface(s) 1008 can generally be any hardware and/or software capable of transmitting and/or receiving data via a wired or wireless network connection. Accordingly, network interface(s) 1008 can include a communication transceiver for sending and/or receiving any wired and/or wireless communication.

Computer-readable medium 1012 may be a volatile memory, such as a random access memory (RAM), or a nonvolatile memory, such as nonvolatile random access memory (NVRAM), or the like. In this example, computer-readable medium 1012 includes a monitoring changes to pod replicas component 1014, detecting changes pod replicas component 1016, determining RMR component 1018, updating maximum number of pod replicas with the RMR component 1020, increasing the number of pod replicas component 1022, increasing CPUs and memory in an RQ component 1024, and updating an HPA manifest with the RMR component 1026.

In certain embodiments, the monitoring changes to pod replicas component 1014 is configured to monitor changes to pod replicas as described above with reference to FIG. 2 and FIG. 6.

In certain embodiments, the detecting changes pod replicas component 1016 is configured to detect changes in pod replicas as described above with reference to Eq. (2).

In certain embodiments, the determining RMR component 1018 is configured to determine an RMR as described above with reference to FIG. 7.

In certain embodiments, the updating maximum number of pod replicas with the RMR component 1020 is configured to update the maximum number of pod with the RMR as described above with reference to FIGS. 4A-4B.

In certain embodiments, the increasing the number of pod replicas component 1022 is configured to increase the number of pod replicas as described above with reference to FIG. 2A-2D.

In certain embodiments, the increasing CPUs and memory in an RQ component 1024 is configured to increase the number of CPUs and amount of in the RQ as described above with reference to FIGS. 4A-4B.

In certain embodiments, the updating an HPA manifest with the RMR component 1026 is configured to update the HPA manifest as described above with reference to FIGS. 4A-4B and FIG. 8.

Note that FIG. 14 is just one example of a processing system consistent with aspects described herein, and other processing systems having additional, alternative, or fewer components are possible consistent with this disclosure.

### Example Clauses

Implementation examples are described in the following numbered clauses:

Clause 1: A computer-implemented method, comprising: monitoring current pod replicas that run an application or microservice in a cluster of nodes; determining a recommended maximum number of pod replicas (RMR) that is greater than a current maximum number of pod replicas in response to detecting a change in the current pod replicas; overwriting the current maximum number of pod replicas of an HPA manifest with the RMR; and executing an increased number of pod replicas to run the application or the microservice in the cluster based on the RMR recorded in the HPA manifest, wherein the increased number of pod replicas is greater than a current number of the pod replicas and is less than the RMR.

Clause 2. The method of Clause 1, wherein determining the RMR comprises: fetching the current number of pod replicas and the current maximum number of pod replicas from the HPA manifest in response to detecting the change in the pod replicas; and fetching a set of current metric values of metrics of the application or the microservice running in the current pod replicas and a target metric value from the HPA manifest in response to the current number of pod replicas being greater than the current maximum number of pod replicas multiplied by a configurable threshold, and for a respective metric of the metrics, in response to a current metric value of the respective metric multiplied by the current number of pod replicas being greater than the target metric value of the respective metric multiplied by the current maximum number of pod replicas and the configurable threshold: determining the RMR by multiplying the current maximum number of pod replicas by a scale factor, and overwriting the current maximum number of pod replicas in a horizontal pod autoscaler (HPA) recommendation customer resource (CR) with the RMR.

Clause 3. The method of any of Clause 1-2, wherein fetching the current metric values for the metrics of the application or the microservice comprises using a metrics API to fetch the current metric values from a metrics monitoring tool that collects metrics of the application or the microservice running in the pod replicas.

Clause 4. The method of any of Clauses 1-3, wherein the current metric value of the respective metric comprises a current CPU value of the respective metric and the target metric value of the respective metric comprises a target CPU value.

Clause 5. The method of Clauses 1-4, wherein the current metric value of the respective metric comprises a current memory value of the respective metric and the target metric value of the respective metric comprises a target memory value.

Clause 6. The method of Clauses 1-5, wherein updating the maximum number of pod replicas of the HPA to the recommended maximum number of pod replicas comprises: fetching the RMR from the HPA recommendation CR in response to detecting a change from the current maximum number of pod replicas to the RMR in the HPA recommendation CR; retrieving a number of CPUs and an amount of memory used to run the current number of pod replicas from a resource quota; determining whether the number of CPUs and the amount of memory are able to run the RMR; increasing the number of CPUs and the amount of memory to run the RMR in response to the number of CPUs and the amount of memory retrieved from the resource quota being insufficient to run the RMR; and updating the current maximum number of replicas of the HPA manifest to match the RMR.

Clause 7. The method of Clauses 1-6, further comprising executing a decreased number of pod replicas that run the application or the microservice in the nodes in response to a decrease in CPU usage and memory usage in the current pod replicas.

Clause 8: A processing system, comprising: a memory comprising computer-executable instructions; and a processor configured to execute the computer-executable instructions and cause the processing system to perform a method in accordance with any one of Clauses 1-7.

Clause 9: A processing system, comprising means for performing a method in accordance with any one of Clauses 1-7.

Clause 10: A non-transitory computer-readable medium storing program code for causing a processing system to perform the steps of any one of Clauses 1-7.

Clause 11: A computer program product embodied on a computer-readable storage medium comprising code for performing a method in accordance with any one of Clauses 1-7.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
monitoring current pod replicas that run an application or microservice in a cluster of nodes;
determining a recommended maximum number of pod replicas (RMR) that is greater than a current maximum number of pod replicas in response to detecting a change in the current pod replicas;
overwriting the current maximum number of pod replicas of an HPA manifest with the RMR; and
executing an increased number of pod replicas to run the application or the microservice in the cluster based on the RMR recorded in the HPA manifest, wherein the increased number of pod replicas is greater than a current number of the pod replicas and is less than the RMR.

2. The method of claim 1, wherein determining the RMR comprises:
fetching the current number of pod replicas and the current maximum number of pod replicas from the HPA manifest in response to detecting the change in the pod replicas; and
fetching a set of current metric values of metrics of the application or the microservice running in the current pod replicas and a target metric value from the HPA manifest in response to the current number of pod replicas being greater than the current maximum number of pod replicas multiplied by a configurable threshold, and
for a respective metric of the metrics,
in response to a current metric value of the respective metric multiplied by the current number of pod replicas being greater than the target metric value of the respective metric multiplied by the current maximum number of pod replicas and the configurable threshold:
determining the RMR by multiplying the current maximum number of pod replicas by a scale factor, and
overwriting the current maximum number of pod replicas in a horizontal pod autoscaler (HPA) recommendation customer resource (CR) with the RMR.

3. The method of claim 2, wherein fetching the set of current metric values for the metrics of the application or the microservice comprises using a metrics API to fetch the set of current metric values from a metrics monitoring tool that collects metrics of the application or the microservice running in the pod replicas.

4. The method of claim 2, wherein the current metric value of the respective metric comprises a current CPU value of the respective metric and the target metric value of the respective metric comprises a target CPU value.

5. The method of claim 2, wherein the current metric value of the respective metric comprises a current memory value of the respective metric and the target metric value of the respective metric comprises a target memory value.

6. The method of claim 2, wherein updating the maximum number of pod replicas of the HPA to the recommended maximum number of pod replicas comprises:
fetching the RMR from the HPA recommendation CR in response to detecting a change from the current maximum number of pod replicas to the RMR in the HPA recommendation CR;
retrieving a number of CPUs and an amount of memory used to run the current number of pod replicas from a resource quota;
determining whether the number of CPUs and the amount of memory are able to run the RMR;
increasing the number of CPUs and the amount of memory to run the RMR in response to the number of CPUs and the amount of memory retrieved from the resource quota being insufficient to run the RMR; and
updating the current maximum number of replicas of the HPA manifest to match the RMR.

7. The method of claim 1, further comprising executing a decreased number of pod replicas that run the application or the microservice in the nodes in response to a decrease in CPU usage and memory usage in the current pod replicas.

8. A processing system, comprising:
one or more memories comprising computer-executable instructions; and
one or more processors configured to execute the computer-executable instructions and cause the processing system to:
monitor current pod replicas that run an application or microservice in a cluster of nodes;
determine a recommended maximum number of pod replicas (RMR) that is greater than a current maximum number of pod replicas in response to detecting a change in the current pod replicas;
overwrite the current maximum number of pod replicas of an HPA manifest with the RMR; and
execute an increased number of pod replicas to run the application or the microservice in the cluster on the RMR recorded in the HPA manifest, wherein the increased number of pod replicas is greater than a current number of the pod replicas and is less than the RMR.

9. The processing system of claim 8, wherein to determine the RMR the one or more processors are configured to cause the processing system to:
fetch the current number of pod replicas and the current maximum number of pod replicas from the HPA manifest in response to detecting the change in the pod replicas; and
fetch a set of current metric values of metrics of the application or the microservice running in the current pod replicas and a target metric value from the HPA manifest in response to the current number of pod replicas being greater than the current maximum number of pod replicas multiplied by a configurable threshold, and
for a respective metric of the metrics,
in response to a current metric value of the respective metric multiplied by the current number of pod replicas being greater than the target metric value of the respective metric multiplied by the current maximum number of pod replicas and the configurable threshold:
determine the RMR by multiplying the current maximum number of pod replicas by a scale factor, and
overwrite the current maximum number of pod replicas in a horizontal pod autoscaler (HPA) recommendation customer resource (CR) with the RMR.

10. The processing system of claim 9, wherein to fetch the set of current metric values for the metrics of the application or the microservice the one or more processors are configured to cause the processing system to use a metrics API to fetch the set of current metric values from a metrics monitoring tool that collects metrics of the application or the microservice running in the pod replicas.

11. The processing system of claim 9, wherein the current metric value of the respective metric comprises a current CPU value of the respective metric and the target metric value of the respective metric comprises a target CPU value.

12. The processing system of claim 9, wherein the current metric value of the respective metric comprises a current memory value of the respective metric and the target metric value of the respective metric comprises a target memory value.

13. The processing system of claim 9, wherein to update the maximum number of pod replicas of the HPA to the recommended maximum number of pod replicas the one or more processors are configured to cause the processing system to:
fetch the RMR from the HPA recommendation CR in response to detecting a change from the current maximum number of pod replicas to the RMR in the HPA recommendation CR;
retrieve a number of CPUs and an amount of memory used to run the current number of pod replicas from a resource quota;
determine whether the number of CPUs and the amount of memory are able to run the RMR;
increase the number of CPUs and the amount of memory to run the RMR in response to the number of CPUs and the amount of memory retrieved from the resource quota being insufficient to run the RMR; and
update the current maximum number of replicas of the HPA manifest to match the RMR.

14. The processing system of claim 8, the one or more processors are configured to cause the processing system to execute a decreased number of pod replicas that run the application or the microservice in the nodes in response to a decrease in CPU usage and memory usage in the current pod replicas.

15. An apparatus, comprising:
a recommender engine configured to monitor current pod replicas that run an application in a cluster of nodes, to determine a recommended maximum number of pod replicas (RMR) that is greater than a current maximum number of pod replicas in response to detecting that a current number of the pod replicas is near the current maximum number of pod replicas, and to update a horizontal pod autoscaler (HPA) recommendation customer resource (CR) with the RMR;
an updater engine configured to update the current maximum number of pod replicas of an HPA manifest of the application with the RMR in response to detecting the HPA recommendation CR has been updated with RMR; and
a replication controller configured to execute an increased number of pod replicas that run the application in the nodes, wherein the increased number of pod replicas that run the application in the nodes is greater than the current number of pod replicas and is less than the RMR.

16. The apparatus of claim 15, wherein in order to update the HPA recommendation CR with the RMR, the recommender engine is configured to:
fetch the current number of pod replicas and the current maximum number of pod replicas from the HPA manifest in response to detecting a change in the current pod replicas; and
fetch a set of current metric values of metrics of the application or microservice running in the current pod replicas and a target metric value from the HPA manifest in response to the current number of pod replicas being greater than the current maximum number of pod replicas multiplied by a configurable threshold, and
for a respective metric of the metrics,
in response to a current metric value of the respective metric multiplied by the current number of pod replicas being greater than the target metric value of the respective metric multiplied by the current maximum number of pod replicas and the configurable threshold:
determining the RMR by multiplying the current maximum number of pod replicas by a scale factor, and
overwriting the current maximum number of pod replicas in the HPA recommendation CR with the RMR.

17. The apparatus of claim 16, wherein in order to fetch the current metric values for the metrics of the application or the microservice the recommender engine is configured to use a metrics API to fetch the current metric values from a metrics monitoring tool that collects metrics of the application or the microservice running in the pod replicas.

18. The apparatus of claim 16, wherein the current metric value of the respective metric comprises a current CPU value of the respective metric and the target metric value of the respective metric comprises a target CPU value.

19. The apparatus of claim 16, wherein the current metric value of the respective metric comprises a current memory value of the respective metric and the target metric value of the respective metric comprises a target memory value.

20. The apparatus of claim 15, wherein in order to update the current maximum number of pod replicas of the HPA manifest of the application with the RMR, the updater engine is configured to:
monitor the HPA recommendation CR for a change in the RMR;
read the RMR from the HPA recommendation CR in response to detecting a change from the current maximum number of pod replicas to the RMR in the HPA recommendation CR;
retrieve a number of CPUs and an amount of memory used to run the current number of pod replicas from a resource quota;
determine whether the number of CPUs and the amount of memory are able to run the recommended maximum number of pod replicas;
increase the number of CPUs and the amount of memory in the resource quota to run the RMR in response to the number of CPUs and the amount of memory retrieved from the resource quota being insufficient to run the RMR; and
update a current maximum number of replicas of the HPA manifest to match the RMR.
